(19) United States
(12) Patent Application Publication
(10) Pub. No.: US 2012/0160363 A1
(43) Pub. Date: Jun. 28, 2012

(54) HIGH MANGANESE CONTAINING STEELS FOR OIL, GAS AND PETROCHEMICAL APPLICATIONS

(75) Inventors: Hyun Woo Jin, Easton, PA (US); Raghavan Ayer, Basking Ridge, NJ (US); Douglas Paul Fairchild, Sugar Land, TX (US); Mario L. Macia, Bellaire, TX (US)

(73) Assignee: EXXONMOBIL RESEARCH AND ENGINEERING COMPANY, Annandale, NJ (US)

(21) Appl. No.: 13/332,650

(22) Filed: Dec. 21, 2011

Related U.S. Application Data
(60) Provisional application No. 61/427,543, filed on Dec. 28, 2010.

(51) Int. Cl. F16L 9/00; C22C 37/00; C22C 38/04; C22C 37/10; C22C 37/06; B23K 11/00; C22C 38/18; C22C 38/38; C22C 38/08; C22C 38/16; C22C 38/02; B23K 20/12; C22C 38/00; C22C 38/36

(52) U.S. Cl. 138/177; 420/9; 420/13; 420/72; 420/99; 420/120; 420/10; 420/11; 420/15; 420/34; 420/74; 420/100; 420/104; 420/27; 420/94; 420/28; 420/77; 420/103; 420/89; 420/117; 228/112.1; 228/101; 219/148

(57) ABSTRACT

Provided are high manganese containing ferrous based components and their use in oil, gas and/or petrochemical applications. In one form, the components include 5 to 40 wt % manganese, 0.01 to 3.0 wt % carbon and the balance iron. The components may optionally include one or more alloying elements chosen from chromium, nickel, cobalt, molybdenum, niobium, copper, titanium, vanadium, nitrogen, boron and combinations thereof.

### CROSS-REFERENCE TO RELATED APPLICATIONS

This application claims priority to U.S. Provisional Application Ser. No. 61/427,543 filed Dec. 28, 2010, herein incorporated by reference in its entirety.

### FIELD

The present disclosure relates to the field of high manganese (Mn) containing steels. It more particularly relates to the application of such manganese containing steels for oil, gas and petrochemical applications.

### BACKGROUND

Cryogenic structures such as liquified natural gas (LNG) container vessels demand for steels with specific low temperature properties. The steels need to remain ductile and crack resistant with a high level of safety even at cryogenic temperatures (<−100° C.). They must also have high strength in order to allow reduction of wall thickness of tanks which permits low cost construction. Conventional carbon steels lose much of their toughness and become brittle at cryogenic temperatures. Steels commonly used for structural applications at cryogenic temperatures are alloy steels such as Fe-9 wt % Ni steel, austenitic stainless steels (e.g., 304 SS with Fe-18 wt % Cr-8 wt % Ni), invar alloys (Fe-36 wt % Ni), and aluminum alloys.

Aluminum alloys are used in various cryogenic applications due to their high specific strength and ductility. However, most aluminum alloys are low strength compared with strength of alloyed steel and are relatively challenging to weld. Austenitic stainless steels (e.g., 304 SS) and invar alloys are relatively low strength and high cost. Nickel-alloyed high-strength steels (5% Ni and 9% Ni) provide a combination of high cryogenic strength and toughness and hence 9% Ni steels are often preferred for the most demanding low temperature applications. However, as the result of high Ni content, these alloys are expensive.

Liquefied natural gas is usually transported by specially equipped ships and stored in LNG-terminals. Conventional LNG carrier ships are of two basic types. The first type (Moss type) uses heavy wailed self-supporting spherical tanks made of aluminum to contain the LNG. The second type (membrane type) uses a thin membrane of Invar alloy or corrugated austenitic stainless steel supported by the ship's hull (with plywood and insulation in between) to contain the LNG. In membrane type LNG tanks, membrane steels are joined by fusion welding technology for liquid-tightness. Typical joining techniques utilized in the field are GTAW (Gas Tungsten Arc Welding), GMAW (Gas Metal Arc Welding), SMAW (Shielded Metal Arc Welding), and SAW (Submerged Arc Welding).

Even though extensive studies have been made on welding technologies for cryogenic steels, it is still challenging to cost effectively meet weld property requirements in cryogenic steel weldments. In case of 9% Ni steel, for instance, achieving stable cryogenic toughness in the as-welded state (without heat treatment) can be challenging when a weldment is fabricated with similar composition filler wire. For this reason, Ni-based alloy composition weld wire is typically used for joining 9% Ni steels. Weldments with Ni-based alloy weld wire, however, show tower yield strength than that of 9% Ni steel, thus imposing limitations in utilizing the full strength of the 9% Ni steel. Furthermore, weldments with Ni-based weld wires can be susceptible to high temperature cracking (during welding) and fatigue damage due to a difference in thermal expansion coefficient. In addition, high nickel content increases the cost of welding consumables.

In the Canadian oil sands resources in north-eastern Alberta, a large amount of oil sands are covered by little overburden, making surface mining the most efficient method of extraction. The sands are often mined with shovels and moved to the processing plants by hydro-transport pipeline where granular material oil sand is transported as aqueous slurry. After bitumen extraction, tailings are transported by pipeline from processing facilities to sites where separation of solids and water occurs. The hydro-transport of massive amounts of slurry mixture causes significant metal loss in conventional metallic pipelines, which results in short replacement cycles and considerable cost.

Current pipe structures for slurry hydro-transport are typically made from low carbon, pipeline grade steel (e.g., API 5L X70). It has been observed that fast moving solids in the slurry flow can cause considerable metal loss of the inner pipe wall. The aqueous and aerated slurry flow causes accelerated pipe erosion by providing for a corrosive environment. Under the influence of gravity, particulate matter in the slurry causes damage along the bottom inside half of the pipes. Hence, some mine operators have implemented the practice of periodically rotating pipelines to maximize lifespan. Nevertheless, pipe erosion remains a serious problem, and alternative pipe structures or materials are sought to provide a more economical operation.

Based on the foregoing problems, a need exists for improved steel compositions for components and structures in the oil, gas and petrochemical industry in order to improve ductility, crack resistance, strength, and erosion resistance, and the foregoing properties at cryogenic temperatures. There is also a need for low cost steels that exhibit both high strength and toughness at cryogenic temperatures.

### SUMMARY

According to the present disclosure, an advantageous high manganese containing ferrous based component for oil, gas and/or petrochemical applications includes: 5 to 40 wt % manganese, 0.01 to 3.0 wt % carbon and the balance iron.

A further aspect of the present disclosure relates to an advantageous method of using a high manganese containing ferrous based component for oil, gas and/or petrochemical applications including: providing a component including 5 to 40 wt % manganese, 0.01 to 3.0 wt % carbon and the balance iron, and utilizing the component in oil, gas and/or petrochemical applications.

These and other features and attributes of the disclosed high manganese containing ferrous based components and their application in the oil, gas and petrochemical industry will be apparent from the detailed description which follows, particularly when read in conjunction with the figures appended hereto.

### BRIEF DESCRIPTION OF DRAWINGS

To assist those of ordinary skill in the relevant art in making and using the subject matter hereof, reference is made to the appended drawings, wherein:

FIG. 1 depicts an exemplary schematic of the phase stability and deformation mechanism of high Mn steels as a function of alloy chemistry and temperature.

FIG. 2 depicts an alternative exemplary schematic of the friction stir welding process with high Mn steels.

FIG. 3 depicts the flow strength of high Mn steels at ambient and elevated temperatures during friction stir welding.

### DEFINITIONS

CRA: Corrosion resistant alloys. A specially formulated material used for completion components likely to present corrosion problems. Corrosion-resistant alloys may be formulated for a wide range of aggressive conditions.

Ductility: A measure of a material's ability to undergo appreciable plastic deformation before fracture; it may be expressed as percent elongation (% EL) or percent area reduction (% AR).

Erosion resistance: A material's inherent resistance to erosion when exposed to moving solid particulates striking the surface of the material.

Toughness: Resistance to fracture initiation.

Fatigue: Resistance to fracture under cyclic loading.

Fretting fatigue: Fretting involves contact between surfaces undergoing small cyclic relative tangential motion. Fretting fatigue resistance is resistance to fracture in a notched metal parts or metal parts with holes.

Yield Strength: Ability to bear load without deformation.

FS: Friction stir.

FSW: Friction stir welding.

Friction Stir Welding: A solid state joining process for creating a welded joint between two work pieces in which the heat for joining the metal work pieces is generated by plunging a rotating pin of a tool between the work pieces.

FSP: Friction stir processing.

Friction stir processing: The method of processing and conditioning the surface of a structure by pressing a FSW tool against the surface by partially plunging a pin into the structure.

Weld joint: A welded joint including the fused or thermo-mechanically altered metal and the base metal in the “near vicinity” of, but beyond the fused metal. The portion of the base metal that is considered within the “near vicinity” of the fused metal varies depending on factors known to those in the welding art.

Weldment: An assembly of component parts joined by welding.

Weldability: The feasibility of welding a particular metal or alloy. A number of factors affect weldability including chemistry, surface finish, heat-treating tendencies and the like.

Carbon equivalent: A parameter used to define weldability of steels and expressed by the formula CE=C+Mn/6+(Cr+Mo+V)/5+(Ni+Cu)/15 where all units are in weight percent.

Hydrogen cracking: Cracking that occurs in the weld subsequent to welding.

TMAZ: Thermo-mechanically affected zone.

Thermo-mechanically affected zone: Region of the joint that has experienced both temperature cycling and plastic deformation.

TMAZ-HZ: The hardest region in a weldment.

LNG: Liquefied natural gas. Gas, mainly methane, liquefied under atmospheric pressure and low temperature.

CNG: Compressed natural gas. Natural gas in high-pressure surface containers that is highly compressed (though not to the point of liquefaction).

PLNG: Pressurized liquefied natural gas. Gas, mainly methane, liquefied under moderate pressure and low temperature (higher temperature than LNG).

SCR: Steel catenary riser. A deepwater steel riser suspended in a single catenary from a platform and connected horizontally on the seabed.

TTR: Top tension riser. A riser on offshore oil rigs which is placed in tension to maintain even pressure on marine riser pipe.

Invar: An alloy of iron and nickel specifically designed to have low coefficient of thermal expansion

Duplex: Steel consisting of two phases, specifically austenite and ferrite

Trees: The assembly of valves, pipes, and fittings used to control the flow of oil and gas from a well.

BOP: Blow Out Preventer. The equipment installed at the wellhead to control pressures in the annular space between the casing and drill pipe or tubing during drilling, completion, and work over operations.

OCTG: Oil Country Tubular Goods. A term applied to casing, tubing, plain-end casing liners, pup joints, couplings, connectors and plain-end drill pipe.

Semi-submersibles: Mobile drilling platform with floats or pontoons submerged to give stability while operating. Used in deeper waters down to 360 meters or more. Kept in position by anchors or dynamic positioning.

Jack-up rigs: Mobile drilling platform with retractable legs used in shallow waters less than 100 meters deep.

TLP: Tension Leg Platform. A floating offshore structure held in position by a number of tension-maintaining cables anchored to seabed. Cables dampen wave action to keep platform stationary.

DDCV: Deep Draft Caisson Vessel. Deep draft surface piercing cylinder type of floater, particularly well adapted to deepwater, which accommodates drilling, top tensioned risers and dry completions.

Compliant towers: Narrow, flexible towers and a piled foundation supporting a conventional deck for drilling and production operations. Designed to sustain significant lateral deflections and forces, and are typically used in water depths ranging from 1,500 to 3,000 feet (450 to 900 m).

FPSO: Floating Production Storage and Offloading vessel. A converted or custom-built ship-shaped floater, employed to process oil and gas and for temporary storage of the oil prior to transshipment.

FSO: Floating Storage and Offloading vessel. A floating storage device, usually for oil, commonly used where it is not possible or efficient to lay a pipe-line to the shore. The production platform will transfer the oil to the FSO. Where it will be stored until a tanker arrives and connects to the FSO to offload it.

Tendons: Tubular tethers that permanently moor a floating platform attached at each of the structure's corners.

Umbilicals: An assembly of hydraulic hoses which can also include electrical cables or optic fibers, used to control a subsea structure or ROV from a platform or a vessel.

Tender vessels: A support/supply ship for carrying passengers and supplies to and from facilities dose to shore.

Bottom hole assembly (BHA): Comprised of one or more devices, including but not limited to: stabilizers, variable-gauge stabilizers, back reamers, drill collars, flex drill collars, rotary steerable tools, roller reamers, shock subs, mud motors, logging while drilling (LWD) tools, measuring while drilling (MWD) tools, coring tools, under-reamers, hole openers, centralizers, turbines, bent housings, bent motors, drilling jars, acceleration jars, crossover subs, bumper jars, torque reduction tools, float subs, fishing tools, fishing jars, washover pipe, logging tools, survey tool subs, non-magnetic counterparts of any of these devices, and combinations thereof and their associated external connections.

Casing: Pipe installed in a wellbore to prevent the hole from collapsing and to enable drilling to continue below the bottom of the casing string with higher fluid density and without fluid flow into the cased formation. Typically, multiple casing strings are installed in the wellbore of progressively smaller diameter.

Downhole tools: Devices that are often run retrievably into a well, or possibly fixed in a well, to perform some function in the wellbore. Some downhole tools may be run on a drill stem, such as Measurement While Drilling (MWD) devices, whereas other downhole tools may be run on wireline, such as formation logging tools or perforating guns. Some tools may be run on either wireline or pipe. A packer is a downhole tool that may be run on pipe or wireline to be set in the wellbore to block flow, and it may be removable or fixed. There are many downhole tool devices that are commonly used in the industry.

Drill collars: Heavy wall pipe in the bottom hole assembly near the bit. The stiffness of the drill collars help the bit to drill straight, and the weight of the collars are used to apply weight to the bit to drill forward.

Drill stem: The entire length of tubular pipes, composed of the kelly (if present), the drill pipe, and drill collars, that make up the drilling assembly from the surface to the bottom of the hole. The drill stem does not include the drill bit. In the special case of casing-while-drilling operations, the casing string that is used to drill into the earth formations will be considered part of the drill stem.

Drill stem assembly: Combination of a drill string and bottom hole assembly or coiled tubing and bottom hole assembly. The drill stem assembly does not include the drill bit.

Drill string: The column, or string of drill pipe with attached tool joints, transition pipe between the drill string and bottom hole assembly including tool joints, heavy weight drill pipe including tool joints and wear pads that transmits fluid and rotational power from the top drive or kelly to the drill collars and the bit. In some references, but not in this document, the term “drill string” includes both the drill pipe and the drill collars in the bottomhole assembly.

### DETAILED DESCRIPTION

All numerical values within the detailed description and the claims herein are modified by “about” or “approximately” the indicated value, and take into account experimental error and variations that would be expected by a person having ordinary skill in the art.

The present disclosure relates to high manganese containing ferrous components and the use of such high manganese containing ferrous components in steels for oil and gas exploration, production, transportation and petrochemical applications to improve the reliability and productivity of operations. More particularly, the applicants have discovered that in oil and gas exploration, production, transportation and petrochemical applications, the high manganese containing ferrous components improve one or more of the following properties: ductility, crack resistance, erosion resistance, fatigue life, surface hardness, stress corrosion resistance, fatigue resistance, and environmental cracking resistance.

### Component Composition:

In one exemplary non-limiting embodiment, the high manganese containing ferrous based component for oil, gas and/or petrochemical applications includes: 5 to 40 wt % manganese, 0.01 to 3.0 wt % carbon and the balance iron.

The manganese level in the component may range from 5 to 40, or 10 to 30, or 12 to 25, or 15 to 22 wt % of the total component. The carbon level in the component may range from 0.01 to 3.0, or 0.5 to 2.0, or 0.8 to 1.5 wt % of the total component. Iron constitutes the balance of the component.

In another exemplary non-limiting form, the component may include one or more alloying elements chosen from chromium, aluminum, silicon, nickel, cobalt, molybdenum, niobium, copper, titanium, vanadium, nitrogen, boron and combinations thereof. Weight percentages below are based upon the weight of the total component. Chromium may be included in the component at 0.5 to 30, or 5 to 15, or 8 to 12 wt %. Nickel may be included in the component at 0.5 to 20, or 5 to 15, or 8 to 12 wt %. Cobalt may also be included in the component at 0.5 to 20, or 5 to 15, or 8 to 12 wt %. Aluminum may be included in the component at 0.2 to 15, or 0.5 to 10, or 1.0 to 5, or 1.5 to 3.5, or 2 to 3 wt %. Molybdenum may be included in the component at 0.2 to 10, or 0.5 to 5, or 1.0 to 4, or 1.5 to 3.5, or 2 to 3 wt %. Silicon may be included in the component at 0.2 to 10, or 0.5 to 5, or 1.0 to 4, or 1.5 to 3.5, or 2 to 3 wt %. Similarly, niobium, copper, titanium and vanadium may each be included in the component at 0.2 to 10, or 0.5 to 5, or 1.0 to 4, or 1.5 to 3.5, or 2 to 3 wt %. Nitrogen may be included in the component at 0.01 to 3.0, or 0.5 to 2.0, or 0.6 to 1.6, or 0.8 to 1.4, or 1.0 to 1.2 wt %. Boron may be included in the component at 0.001 to 0.1, or 0.002 to 0.05, or 0.005 to 0.01 wt %.

The high manganese containing ferrous based component for oil, gas and/or petrochemical applications may also include other alloying elements chosen from zirconium, hafnium and combinations thereof. Each of these other alloying elements may be included in the component in ranges from 0.2 to 6, or 0.5 to 5, or 1.0 to 4, or 1.5 to 3.5, or 2 to 3 wt % based on the total weight of the component.

The mechanical properties of high Mn steels are strongly dependent on the characteristics of strain-induced transformation, which is controlled by the chemical composition of the steels and the processing temperatures. Unlike conventional carbon steels, high Mn steels include a metastable austenite phase with a face centered cubic (fcc) structure at ambient temperature. Upon straining, the metastable austenite phase can transform into several other phases through strain-induced transformation. Specifically, the austenite phase could transform into microtwins (fcc) structure twin aligned with matrix), ε-martensite (hexagonal lattice), and α′-martensite (body centered tetragonal lattice) depending on steel chemistry and temperature. These transformation products could impart a range of unique properties to high Mn steels. For example, fine microtwins effectively segment primary grains and act as strong obstacles for dislocation gliding. This leads to effective grain refinement which results in an excellent combination of high ultimate strength and ductility.

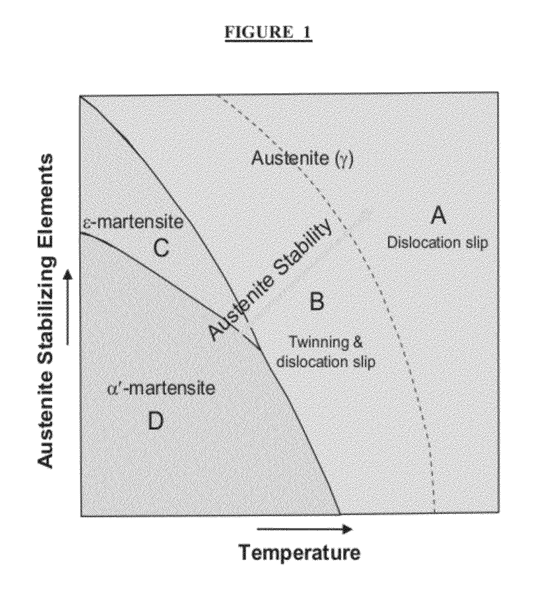

Chemical composition and temperature are known to be primary factors controlling the strain-induced phase transformation pathways as shown in FIG. 1. High Mn steels can be divided into four groups depending on the stability of austenite phase upon straining and temperature, i.e., hilly stable (A), mildly metastable (B), moderately metastable (C) and highly metastable (D) Mn steel. The metastability of these is affected by both temperature and strain. These steels would tend to be more metastable (i.e., higher tendency to transform) at lower temperatures and higher strains.

FIG. 1 is an exemplary diagram of the phase stability and deformation mechanism of high Mn steels as a function of alloy chemistry and temperature. The letters (A, B, C, and D) indicates the various methods of transformation during deformation. In this diagram, steel A would deform by slip (like all metals and alloys) while steels B-D would transform during deformation.

Steel A, with high Mn content (e.g., ≧25 wt %), has stable austenite and deforms primarily by dislocation slip upon mechanical straining. Steels with a fully stabilized austenitic structure show lower mechanical strength but remain tough at cryogenic temperatures, provide low magnetic permeability and are highly resistant to hydrogen embrittlement. These steels have been developed for superconducting technologies used in magnetic levitation transportation systems and nuclear fusion research

Steel B, which is mildly metastable, can be produced with intermediate manganese content (e.g., 15˜25 wt % Mn, ˜0.6 wt % C) and these steels form twins during deformation. A large amount of plastic elongation can be achieved by the formation of extensive deformation twins along with dislocation slip, a phenomenon known as Twinning-Induced Plasticity (TWIP). Twinning causes a high rate of work hardening as the microstructure is effectively refined as the twin boundaries act like grain boundaries and strengthen the steel due to the dynamic Hall-Petch effect. TWIP steels combine extremely high tensile strength (>150 ksi) with extremely high uniform elongation (>95%) rendering it highly attractive for automotive applications.

The moderately metastable steels, Steel C, can transform into it ε-martensite (hexagonal lattice) upon straining. Upon mechanical straining, these steels would deform predominantly by the formation of ε-martensite, along with dislocation slip and/or mechanical twinning.

The highly metastable steels, Steel D, will transform to a strong body-centered cubic phase (referred to as α′-martensite) upon deformation. This strong phase would provide resistance to erosion resulting from the impingement of external, hard, particles. Since the impact of the external particles results in the deformation of the near surface regions of the steel, these surface regions would transform during service providing resistance to erosion. Therefore, these steels, have a “self healing” characteristics in the sense that if the hard surface layer gets damaged, it would reform by the impact of the service.

Thus, the chemistry of the high Mn steels can be tailored to provide a range of properties (cryogenic toughness, high formability, erosion resistance) by controlling their transformation during deformation for the oil and gas applications.

### Other Alloying Concepts in High Mn Steels

Alloying elements in high Mn steels determine the stability of the austenite phase and strain-induced transformation pathways. Manganese is the main alloying element in high Mn steels and it is crucial in stabilizing the austenitic structure both during cooling and deformation. In the Fe—Mn binary system, with increasing Mn content, the strain induced phase transformation pathway changes from α′-martensite to ε-martensite and then to micro-twinning.

Carbon is an effective austenite stabilizer and the carbon solubility is high in austenite phase. Therefore, carbon alloying can be used to stabilize the austenite phase during cooling from the melt and during plastic deformation. Carbon also strengthens the matrix by solid solution hardening. The high manganese containing ferrous based component for oil, gas and/or petrochemical applications disclosed herein may include up to 3.0 wt % carbon based on the total weight of the component. In other forms, the carbon in the components may range from 0.01 to 3.0, or 0.5 to 2.0, or 0.8 to 1.5 wt % of the total component.

Aluminum is a ferrite stabilizer and thus destabilizes austenite phase during cooling. The addition of aluminum to high Mn steels, however, stabilizes the austenite phase against strain-induced phase transformation during deformation. Furthermore, it strengthens the austenite by solid solution hardening. The addition of aluminum also enhances the corrosion resistance of the high manganese containing ferrous based components disclosed herein due to its high passivity. The high manganese containing ferrous based component for oil, gas and/or petrochemical applications disclosed herein may include up to 15.0 wt % aluminum based on the total weight of the component. In other forms, the aluminum in the components may range from at 0.2 to 15, or 0.5 to 10, or 1.0 to 5, or 1.5 to 3.5, or 2 to 3 wt % of the total component.

Silicon is a ferrite stabilizer and sustains the α′-martensite transformation while promoting ε-martensite formation upon deformation at ambient temperature. Due to solid solution strengthening, addition of Si strengthens the austenite phase by ˜50 MPa per 1 wt % addition of Si. The high manganese containing ferrous based component for oil, gas and/or petrochemical applications disclosed herein may include up to 10.0 wt % silicon based on the total weight of the component. In other forms, the silicon in the components may range from at 0.2 to 10, or 0.5 to 5, or 1.0 to 4, or 1.5 to 3.5, or 2 to 3 wt % of the total component.

Chromium additions to high Mn steels alloys enhance the formation of ferrite phase during cooling and increase corrosion resistance. Furthermore, the addition of Cr to the Fe—Mn alloy system reduces thermal expansion coefficient. The high manganese containing ferrous based component for oil, gas and/or petrochemical applications disclosed herein may include up to 30 wt % chromium based on the total weight of the component. In other forms, the chromium in the components may range from at 0.5 to 30, or 5 to 15, or 8 to 12 wt %. of the total component.

Based on the understanding of these alloying element effects on strain-induced phase transformation, suitable steel chemistries can be designed for specific applications. One criterion for design of high Mn steels can be critical martensite transformation temperatures, i.e., Mₛ and M_{εs}. Mₛ is a critical temperature below which austenite to α′-martensite transformation occurs and M_{εs} is a critical temperature below which austenite to ε-martensite transformation takes place.

The effects of alloying elements on Mₛ and M_{εs} can be expressed as follows.

Mₛ(K)=A₃−410−200(C+1.4N)−18Ni−22Mn−7Cr−45Si−56Mo (Unit of alloying elements in weight percent)

M_{εs}(K)=670−710(C+1.4N)−19Ni−12Mn−8Cr+13Si−2Mo−23Al (Unit of alloying elements in weight percent)

where A₃ is a critical temperature above which all ferrite phases (including α′- and ε-martensite phases) transform to austenite.

Only austenite to α′-martensite transformation takes place if Mₛ is much higher than M_{εs}. If M_{εs} is much higher than Mₛ, only austenite to ε-martensite transformation takes place. Both α′-martensite and ε-martensite phase transformation occur if Mₛ and M_{εs} are close to each other.

### Applications in Oil, Gas and Petrochemical Industry:

The high manganese containing ferrous based components disclosed herein may find numerous, non-limiting exemplary applications in the oil, gas and/or petrochemical industry. In one embodiment, a method of using a high manganese containing ferrous based component for oil, gas and/or petrochemical applications includes providing a component including 5 to 40 wt % manganese, 0.01 to 3.0 wt % carbon and the balance iron, and utilizing the component in oil, gas and/or petrochemical applications. Potential applications of high Mn steels in the oil, gas and petrochemical industry include cryogenic applications such as LNG trains, LNG carrier vessels, LNG off-loading lines and storage vessels, corrosion resistant tubes/pipes/flowlines/risers for sour service and erosion-corrosion resistant slurry transport pipelines, crushers, mix boxes, hydrotransport pumps in oil sand mining/extraction operations.

High Mn steels have the potential to replace conventional cryogenic steels (e.g., 9% Ni steels, austenitic stainless steels, and invar alloys) which are more expensive due to high Ni alloying. Exemplary, non-limiting applications of high Mn steels include LNG liquefaction/gasification piping and equipment, LNG loading arms, LNG loading/unloading lines, LNG vapor return lines, membranes for LNG carriers, LNG storage vessels, LNG cryogenic valves/bellows, subsea cryogenic pipelines, risers, and flow lines.

Relatively low alloying content (e.g., ≦15 wt % Mn, ˜1.5 wt % C) produces highly metastable austenite phase. Highly metastable austenite phase often transforms into hard α′-martensite upon straining, which is an irreversible transformation. Upon surface wear of these steels, a surface layer of the highly metastable austenite phase can transform to α′-martensite phase. This friction-induced phase transformation leads to the formation of a thin, hard surface layer composed of martensite over an interior that consists of tough, untransformed austenite. This unique combination renders high Mn steels suitable for wear/erosion and impact resistant applications (e.g., slurry transport pipe, tailing pipe, mix box, crusher, and other oil sand mining/bitumen extraction equipment).

The high manganese containing ferrous based component for oil, gas and/or petrochemical applications may find application in high strength pipelines, steel catenary risers, top tension risers, threaded components, liquefied natural gas containers, pressurized liquefied natural gas containers, deep water oil drill strings, riser/casing joints, and well-head equipment. More particularly, the components disclosed herein may be used in natural gas liquefaction, transportation and storage type structures and components, which includes, but is not limited to, natural gas liquefaction, transportation and storage type structures and components are chosen from pipelines, flow lines, gathering lines, transmission lines, shipping vessels, transferring components, storage tanks, and expansion loops. The natural gas is in the form of LNG, CNG, or PLNG.

The high manganese containing ferrous based component for oil, gas and/or petrochemical applications may also find application in oil and gas well completion and production structures and components. Non-limiting exemplary oil and gas well completion and production structures and components are chosen from cast structures to flow connections, subsea components, casing/tubing, completion and production components, downhole tubular products, oil pipelines, oil storage tanks, off-shore production structures/components, topsides, deck superstructures, drilling rigs, living quarters, helidecks, umbilicals, tender and supply vessels, and flare towers. Non-limiting exemplary off-shore production structures/components are chosen from jacketed platforms, mobile offshore drilling units, casings, tendons, risers, subsea facilities, semi-submersibles, jack-up rigs, TLPs, DDCVs, compliant towers, IPSO, FSO, ships, and tankers. Exemplary subsea components include duplexes, manifold systems, trees and BOPs.

The high manganese containing ferrous based component for oil, gas and/or petrochemical applications may also find application in subterraneous rotary drilling equipment including a drill string coupled to a bottom hole assembly or a coiled tubing coupled to a bottom hole assembly. The bottom hole assembly comprises one or more components chosen from stabilizers, variable gauge stabilizers, back reamers, drill collars, flex drill collars, rotary steerable tools, roller reamers, shock subs, mud motors, logging while drilling (LWD) tools, measuring while drilling (MWD) tools, coring tools, under-reamers, hole openers, centralizers, turbines, bent housings, bent motors, drilling jars, accelerator jars, crossover subs, bumper jars, torque reduction subs, float subs, fishing tools, fishing jars, washover pipe, logging tools, survey tool subs, non-magnetic counterparts of these components, associated external connections of these components, and combinations thereof.

The high manganese containing ferrous based component for oil, gas and/or petrochemical applications may also find application in oil and gas refinery and chemical plant structures and components. Non-limiting exemplary oil and gas refinery and chemical plant structures and components include cast iron components, heat exchanger tubes, low and high temperature process and pressure vessels, extruder barrels, gears, extruder dies, bearings, compressors, pumps, pipes, tubing, molding dies, transfer lines and process piping, cyclones, slide valve gates and guides, feed nozzles, aeration nozzles, thermo wells, valve bodies, internal risers, deflection shields, fluid catalytic conversion units, fluid cokers and FLEXICOKING units, reactor vessels and combinations thereof. Non-limiting exemplary low and high temperature process and pressure vessels include steam cracker tubes, and steam reforming tubes.

The high manganese containing ferrous based component for oil, gas and/or petrochemical applications may also find application in oil sand mining structures and equipment, coal mining structures and equipment, and coal gasification structures and equipment. More particularly, non-limiting exemplary oil sand mining structures and equipment include excavation equipment, shovel teeth for excavator/loader, slurry transport pipelines, tailing pipes, crushers, mix boxes, screens and hydrotransport pumps.

### Joining of High Mn Steels:

Joining of high Mn steels can be performed with all conventional (fusion, resistance welding etc.) and emerging joining methods (laser, electron beam, friction stir welding etc.). However, the preferred joining method for high Mn steels will be solid state welding methods such as resistance, friction stir welding etc or methods which do not require the use of a weld metal. This is because the phase stability in the high Mn steels is very sensitive to the chemistry. Therefore, any method using a weld metal could create phase instability in the weld metal due to weld dilution. Solid state joining methods which do not require a weld metal do not have these complications and therefore, would be the preferred methods of joining the high Mn steels. In many cases it may even enable the use of the high Mn steels.

In one form a method of using a high manganese containing ferrous based component for oil, gas and/or petrochemical applications includes: providing a component including 10 to 40 wt % manganese, 0.2 to 2.0 wt % carbon and the balance iron, and utilizing the component in oil, gas and/or petrochemical applications, wherein the method further includes joining adjacent segment of two or more components together utilizing a joining method chosen from fusion welding, friction stir welding, flash butt welding, gas tungsten arc welding, gas metal arc welding, shielded metal arc welding, submerged arc welding, flux-cored arc welding, electric resistance welding, laser welding, electron beam welding and combinations thereof bonding adjacent segments of the components together. In another form, a joining method not utilizing a weld metal may be preferable and includes a joining method chosen from friction stir welding, laser welding, electron beam welding, plasma welding, or electric resistance welding.

Joining of high Mn steels of the instant disclosure may be carried out utilizing conventional welding techniques; e.g., flash butt welding, electric resistance welding, or any of the common arc welding processes such as shielded metal arc welding, gas metal arc welding, gas tungsten arc welding, flux-cored arc welding, submerged arc welding. Furthermore the welds can be made with or without filler wires. Fusion welding of high Mn steels should be carried out with low heat input because of hot cracking susceptibility. Prolonged exposure of the high Mn steels to the temperature range of 300° C. to 800° C. can cause embrittlement in the heat affected zone due to carbide precipitation at grain boundaries.

Arc Welding with Fe—Ni Consumables:

One welding technique that is particularly well suited to joining high Mn steels is that of arc welding with Fe—Ni consumables. Fe—Ni consumables are a class of filler materials described in URC PM OAP PM 2009.120. These consumables can be applied using the GTAW, GMAW, SAW, or similar welding processes. The welds made using this technology are capable of matching the good low temperature toughness of high Mn steels while also achieving matching strength (or higher strength depending on the alloying of the Fe—Ni welding consumable).

One useful application of this welding technology is to produce a high strength weld for use in the oil sand slurry pipelines. The Fe—Ni welding can generate very high strength (up to about 160 ksi) which would be useful in matching the wear resistance of the base material.

To account for the high Mn content of the base metal, the Fe—Ni weld consumables should be formulated to accommodate the Mn from weld dilution. Fe—Ni welds typically contain about 0.3% to 0.75% Mn, thus depending on weld dilution, the filler wire could be reduced in Mn to allow for an end weld composition of Mn in this range.

### Friction Stir Welding:

Solid state joining technologies such as, but not limited to, friction stir welding (FSW) and friction welding can be utilized to fabricate joints of the steel compositions disclosed in the instant disclosure.

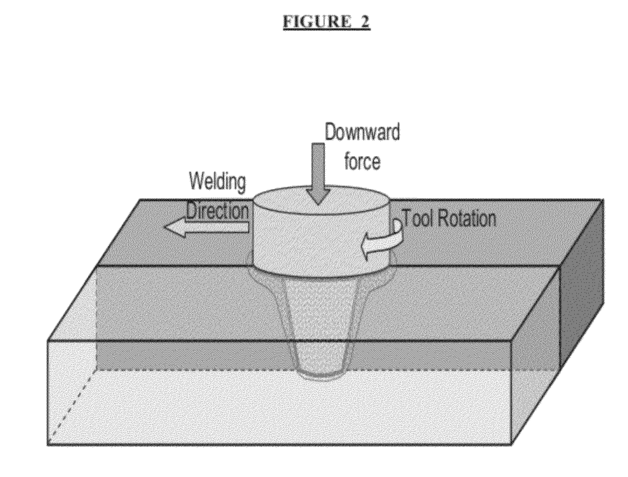

Friction Stir Welding (FSW) is a solid-state joining technology where a rotating tool is used to weld two different workpieces together by generating heat through friction and plasticization. A non-consumable rotating tool is pushed into the materials to be welded and then the central pin, or probe, followed by the shoulder, is brought into contact with the two parts to be joined as shown in FIG. 2.

Rotation of the tool heats up and causes the material of the work pieces to soften into a plastic state without reaching the melting point of work piece material. As the tool moves along the joint line, material from the front of the tool is swept around this plasticized annulus to the rear, eliminating the interface.

The solid-state nature of FSW leads to several advantages over conventional fusion welding methods since any problems associated with solidification from the liquid phase are avoided. FSW can mitigate defects associated with fusion welding such as porosity, solidification cracking and liquidation cracking. The heat affected zone of an FSW joint is exposed to lower peak temperatures than the coarse grain heat affected zone of fusion welds and, hence, has higher toughness.

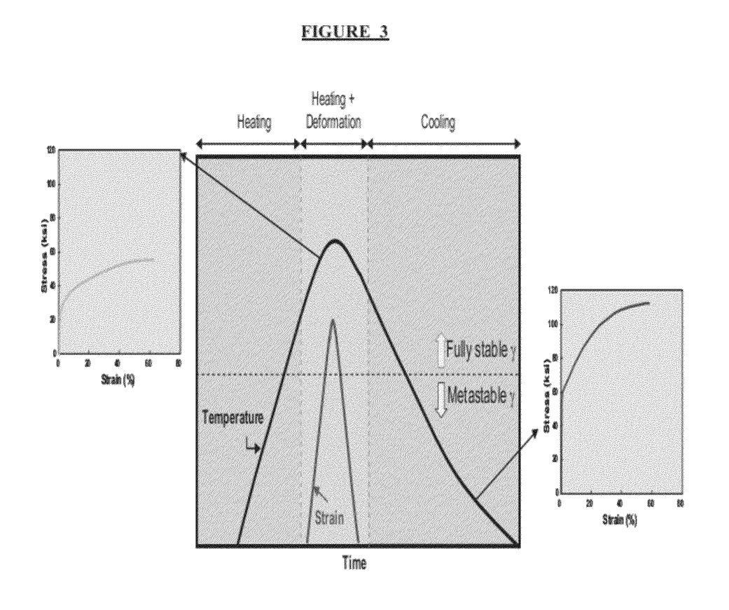

FSW can utilize the temperature dependence of austenite phase stability in high Mn steels. FIG. 3 shows temperature and strain excursions during the friction stir welding. The solid black line indicates temperature variation whereas the red solid line indicates variation of plastic strain during FSW. The horizontal dotted line indicates the temperature above which the austenite phase becomes fully stable for a given steel chemistry (i.e., absence of strain-induced phase transformation). The transition temperature from metastable to fully stable austenite phase depends on the steel chemistry, grain size and cooling rate.

During the course of FSW, steel parts in the joint region experience three general thermo-mechanical stages: heating, heating+plastic deformation, and cooling. In the heating stage, the temperature increases prior to tool arrival due to conduction of the heat from the plasticized region just in front of the tool. The increase in temperature above the horizontal dotted line results in full stabilization of the austenite phase. In the second stage, when the tool arrives, the fully stabilized austenite phase in the steel deforms plastically at low flow stress, facilitating fabrication of FSW joints at much lower temperatures than are created in conventional ferritic steels. In the third stage, the steel undergoes cooling to room temperature. As the temperature falls below the horizontal dotted line (fully stable to metastable austenite transition temperature), the austenite phase becomes metastable, rendering the steel prone to strain-induced phase transformation. The resulting FSW joint would exhibit full benefit of high Mn steels (e.g., high flow strength and work hardening, cryogenic toughness).

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A high manganese containing ferrous based component for oil, gas and/or petrochemical applications comprising: 5 to 40 wt % manganese, 0.01 to 3.0 wt % % carbon and the balance iron.

2. The component of claim 1 further including one or more alloying elements chosen from chromium, aluminum, silicon, nickel, cobalt, molybdenum, niobium, copper, titanium, vanadium, nitrogen, boron and combinations thereof.

3. The component of claim 2, wherein the chromium ranges from 0.5 to 30 wt % of the total component.

4. The component of claim 2, wherein each of the nickel, or cobalt ranges from 0.5 to 20 wt % of the total component.

5. The component of claim 2, wherein the aluminum ranges from 0.2 to 15 wt % of the total component.

6. The component of claim 2, wherein each of the silicon, molybdenum, niobium, copper, titanium, or vanadium ranges from 0.2 to 10 wt % of the total component.

7. The component of claim 2, wherein the nitrogen ranges from 0.2 to 3.0 wt % of the total component.

8. The component of claim 2, wherein the boron ranges from 0.001 to 0.1 wt % of the total component.

9. The component of claim 1 or claim 2 further including one or more other alloying elements chosen from zirconium, hafnium, and combinations thereof.

10. The component of claim 1 or claim 2 further including one or more other alloying elements chosen from zirconium, hafnium, and combinations thereof.

11. The component of claim 9, wherein each of the one or more other alloying elements ranges from 0.2 to 6 wt % of the total component.

12. The component of claim 1 chosen from high strength pipelines, steel catenary risers, top tension risers, threaded components, liquefied natural gas containers, pressurized liquefied natural gas containers, deep water oil drill strings, riser/casing joints, and well-head equipment.

13. The component of claim 1 wherein the component is used in natural gas liquefaction, transportation and storage type structures and components.

14. The component of claim 12, wherein the natural gas liquefaction, transportation and storage type structures and components are chosen from pipelines, flow lines, gathering lines, transmission lines, shipping vessels, transferring components, storage tanks, and expansion loops.

15. The component of claim 13, wherein said natural gas is in the form of LNG, CNG, or PLNG.

16. The component of claim 1 wherein the component is used in oil and gas well completion and production structures and components.

17. The component of claim 15 wherein the oil and gas well completion and production structures and components are chosen from cast structures to flow connections, subsea components, casing/tubing, completion and production components, downhole tubular products, oil pipelines, oil storage tanks, off-shore production structures/components, topsides, deck superstructures, drilling rigs, living quarters, helidecks, umbilicals, tender and supply vessels, and flare towers.

18. The component of claim 16 wherein the off-shore production structures/components are chosen from jacketed platforms, mobile offshore drilling units, casings, tendons, risers, subsea facilities, semi-submersibles, jack-up rigs, TLPs, DDCVs, compliant towers, FPSO, FSO, ships, and tankers.

19. The component of claim 16 wherein said subsea components are chosen from duplexes, manifold systems, trees and BOPs.

20. The component of claim 1 wherein the component is used in subterraneous rotary drilling equipment including a drill string coupled to a bottom hole assembly or a coiled tubing coupled to a bottom hole assembly.

21. The component of claim 19, wherein the bottom hole assembly comprises one or more components chosen from stabilizers, variable-gauge stabilizers, back reamers, drill collars, flex drill collars, rotary steerable tools, roller reamers, shock subs, mud motors, logging while drilling (LWD) tools, measuring while drilling (MWD) tools, coring tools, under-reamers, hole openers, centralizers, turbines, bent housings, bent motors, drilling jars, accelerator jars, crossover subs, bumper jars, torque reduction subs, float subs, fishing tools, fishing jars, washover pipe, logging tools, survey tool subs, non-magnetic counterparts of these components, associated external connections of these components, and combinations thereof.

22. The component of claim 1 wherein the component is used in oil and gas refinery and chemical plant structures and components.

23. The component of claim 22 wherein the oil and gas refinery and chemical plant structures and components are chosen from cast iron components, heat exchanger tubes, low and high temperature process and pressure vessels, extruder barrels, gears, extruder dies, bearings, compressors, pumps, pipes, tubing, molding dies, transfer lines and process piping, cyclones, slide valve gates and guides, feed nozzles, aeration nozzles, thermo wells, valve bodies, internal risers, deflection shields, fluid catalytic conversion units, fluid cokers and FLEXICOKING units, reactor vessels and combinations thereof.

24. The component of claim 22 wherein the low and high temperature process and pressure vessels are chosen from steam cracker tubes, and steam reforming tubes.

25. The component of claim 1 wherein the component is used in oil sand mining structures and equipment, coal mining structures and equipment, and coal gasification structures and equipment.

26. The component of claim 24, wherein the oil sand mining structures and equipment are chosen from excavation equipment, shovel teeth for excavators/loaders, slurry transport pipelines, tailing pipe, crushers, mix boxes, screens and hydrotransport pumps.

27. The component of claim 1 wherein the component exhibits improvements in one or more of the following properties: ductility, crack resistance, erosion resistance, fatigue life, surface hardness, stress corrosion resistance, fatigue resistance, and environmental cracking resistance.

28. The component of claim 1 further including one or more weldments chosen from fusion weldments, friction stir weldments, flash butt weldments, gas tungsten arc weldments, gas metal arc weldments, shielded metal arc weldments, submerged arc weldments, flux-cored arc weldments, electric resistance weldments, laser weldments, plasma weldments, electron beam weldments and combinations thereof bonding adjacent segments of the components together.

29. The component of claim 27 wherein the one or more weldments are friction stir weldments, laser weldments, electron beam weldments, plasma weldments or electric resistance weldments.

30. A method of using a high manganese containing ferrous based component for oil, gas and/or petrochemical applications comprising:
providing a component including 5 to 40 wt % manganese, 0.01 to 3.0 wt % carbon and the balance iron, and
utilizing the component in oil, gas and/or petrochemical applications.

31. The method of claim 29 further including one or more alloying elements chosen from chromium, aluminum, silicon, nickel, cobalt, molybdenum, niobium, copper, titanium, vanadium, nitrogen, boron and combinations thereof.

32. The method of claim 30, wherein the chromium, ranges from 0.5 to 30 wt % of the total component.

33. The method of claim 30, wherein each of the nickel, or cobalt ranges from 0.5 to 20 wt % of the total component.

34. The method of claim 30, wherein the aluminum ranges from 0.2 to 15 wt % of the total component.

35. The method of claim 30, wherein each of the silicon, molybdenum, niobium, copper, titanium, or vanadium ranges from 0.2 to 10 wt % of the total component.

36. The method of claim 30, wherein the nitrogen ranges from 0.2 to 3.0 wt % of the total component.

37. The method of claim 30, wherein the boron ranges from 0.001 to 0.1 wt % of the total component.

38. The method of claim 29 or claim 30 further including one or more other alloying elements chosen from zirconium, hafnium, and combinations thereof.

39. The method of claim 37, wherein each of the one or more other alloying elements ranges from 0.2 to 6 wt % of the total component.

40. The method of claim 29, wherein the component is chosen from high strength pipelines, steel catenary risers, top tension risers, threaded components, liquefied natural gas containers, pressurized liquefied natural gas containers, deep water oil drill strings, riser/casing joints, and well-head equipment.

41. The method of claim 29 wherein the component is used in natural gas liquefaction, transportation and storage type structures and components.

42. The method of claim 40 wherein the natural gas liquefaction, transportation and storage type structures and components are chosen from pipelines, flow lines, gathering lines, transmission lines, shipping vessels, transferring components, storage tanks, and expansion loops.

43. The method of claim 41 wherein said natural gas is in the form of LNG, CNG, or PLNG.

44. The method of claim 29 wherein the component is used in oil and gas well completion and production structures and components.

45. The method of claim 43 wherein the oil and gas well completion and production structures and components are chosen from cast structures to flow connections, subsea components, casing/tubing, completion and production components, downhole tubular products, oil pipelines, oil storage tanks, off-shore production structures/components, topsides, deck superstructures, drilling rigs, living quarters, helidecks, umbilicals, tender and supply vessels, and flare towers.

46. The method of claim 44 wherein said off-shore production structures/components are chosen from jacketed platforms, mobile offshore drilling units, casings, tendons, risers, subsea facilities, semi-submersibles, jack-up rigs, TLPs, DDCVs, compliant to towers, FPSO, FSO, ships, and tankers.

47. The method of claim 44 wherein said subsea components are chosen from duplexes, manifold systems, trees and BOPs.

48. The method of claim 29 wherein the component is used in subterraneous rotary drilling equipment including a drill string coupled to a bottom hole assembly or a coiled tubing coupled to a bottom hole assembly.

49. The method of claim 47, wherein the bottom hole assembly comprises one or more components chosen from stabilizers, variable-gauge stabilizers, back reamers, drill collars, flex drill collars, rotary steerable tools, roller reamers, shock subs, mud motors, logging while drilling (MD) tools, measuring while drilling (MWD) tools, coring tools, under-reamers, hole openers, centralizers, turbines, bent housings, bent motors, drilling jars, accelerator jars, crossover subs, bumper jars, torque reduction subs, float subs, fishing tools, fishing jars, washover pipe, logging tools, survey tool subs, non-magnetic counterparts of these components, associated external connections of these components, and combinations thereof.

50. The method of claim 29 wherein the component is used in oil and gas refinery and chemical plant structures and components.

51. The method of claim 49 wherein the oil and gas refinery and chemical plant structures and components are chosen from cast iron components, heat exchanger tubes, low and high temperature process and pressure vessels, extruder barrels, gears, extruder dies, bearings, compressors, pumps, pipes, tubing, molding dies, transfer lines and process piping, cyclones, slide valve gates and guides, feed nozzles, aeration nozzles, thermo wells, valve bodies, internal risers, deflection shields, fluid catalytic conversion units, fluid cokers and FLEXICOKING units, reactor vessels and combinations thereof.

52. The method of claim 50 wherein the low and high temperature process and pressure vessels are chosen from steam cracker tubes, and steam reforming tubes.

53. The method of claim 29 wherein the component is used in oil sand mining structures and equipment, coal mining structures and equipment, and coal gasification structures and equipment.

54. The method of claim 52, wherein the oil sand mining structures and equipment are chosen from excavation equipment, shovel teeth for excavators/loaders, slurry transport pipelines, tailing pipe, crushers, mix boxes, screens and hydrotransport pumps.

55. The method of claim 29 wherein the component exhibits improvements in one or more of the following properties: ductility, crack resistance, erosion resistance, fatigue life, surface hardness, stress corrosion resistance, fatigue resistance, and environmental cracking resistance.

56. The method of claim 29 further including joining adjacent segment of two or more components together utilizing a joining method chosen from fusion welding, friction stir welding, flash butt welding, gas tungsten arc welding, gas metal arc welding, shielded metal arc welding, submerged arc welding, flux-cored arc welding, electric resistance welding, laser welding, plasma welding, electron beam welding and combinations thereof bonding adjacent segments of the components together.

57. The method of claim 55 wherein the joining method is friction stir welding, laser welding, electron beam welding, plasma welding or electric resistance welding.
